(19) United States
(12) Patent Application Publication
(10) Pub. No.: US 2020/0036780 A1
(43) Pub. Date: Jan. 30, 2020

(54) DISTRIBUTING TASKS

(71) Applicant: Hewlett Packard Enterprise Development LP, Houston, TX (US)

(72) Inventors: Wei HUANG, Beijing (CN); Guangzhi RAN, Beijing (CN)

(21) Appl. No.: 16/520,931

(22) Filed: Jul. 24, 2019

(30) Foreign Application Priority Data
Jul. 25, 2018 (CN) CN 201810825089.3

(51) Int. Cl. H04L 29/08; H04L 12/721

(52) U.S. Cl. CPC H04L 67/1014; H04L 45/566; H04L 67/1078

(57) ABSTRACT

An example method may include determining, by a processor of a network device, a plurality of controllers corresponding to a plurality of client devices; and distributing, by the processor, tasks corresponding to the plurality of client devices to multiple cores of the network device based on the plurality of controllers.

### BACKGROUND

In current WLAN (Wireless Local Area Network) systems, task distribution, e.g., compute distribution, may be based on wireless band. For example, one core is dedicated to 2.4 GHz band, while another core is dedicated to 5 GHz band. This manner of distribution works well if both bands are heavily loaded. However, if the difference of loads between the bands is relatively high, e.g., there is only heavy load on one band over the other, one core works in full horsepower while the other is nearly idle. This can be a resource waste.

### BRIEF DESCRIPTION OF THE DRAWINGS

In the accompanying drawings, like numerals refer to like components or blocks. The following detailed description references the drawings, wherein:

FIGS. 1a and 1b are diagrams illustrating example networking environments for distributing tasks according to the present disclosure;

FIG. 2 is a diagram illustrating an example networking environment for processing downstream/upstream tasks according to the present disclosure;

FIG. 3 is a flow chart illustrating an example method of distributing tasks according to the present disclosure;

FIG. 4 is a flow chart illustrating another example method of distributing tasks according to the present disclosure;

FIG. 5 is a flow chart illustrating another example method of distributing tasks according to the present disclosure;

FIG. 6 is a flow chart illustrating another example method of distributing tasks according to the present disclosure;

FIG. 7 is a flow chart illustrating another example method of distributing tasks according to the present disclosure;

FIG. 8 is a flow chart illustrating another example method of distributing tasks according to the present disclosure;

FIG. 9 is a flow chart illustrating another example method of distributing tasks according to the present disclosure;

FIG. 10 is a block diagram illustrating an example device according to the present disclosure;

FIG. 11 is a block diagram illustrating another example device according to the present disclosure;

FIG, 12 is a block diagram illustrating another example device according to the present disclosure.

FIG. 13 is a block diagram illustrating another example device according to the present disclosure;

FIG. 14 is a block diagram illustrating another example device according to the present disclosure;

FIG. 15 is a block diagram illustrating another example device according to the present disclosure;

FIG. 16 is a block diagram illustrating another example device according to the present disclosure.

### DETAILED DESCRIPTION

As Moore's law slows down, multi-cores CPU have become an important technology to increase system performance by using parallel computing. Accordingly, more and more Access Points (APs) use multi-cores CPU system. Each core can independently process user traffic without affecting the other core(s). Thus, distributing tasks on each core becomes may be useful to make the most of the multi-cores CPU,

On a multi-cores system, different cores may be used for parallel processing in order to increase the system performance. In a wireless system, such as WLAN system, a plurality of controllers may be formed in a cluster to serve a plurality of client devices, e.g., stations. One of the client devices may be assigned to be handled by corresponding one of the controllers in the cluster. The controller may be an access controller (AC). Tasks corresponding to one of the plurality of client devices may be distributed to corresponding one of the controllers in the cluster that the client device is assigned to. Traffic from the client device or to the client device may be tunneled between AP and corresponding controller, e.g. AC.

The present disclosure discloses a new task distribution method and device based on ACs in a multi-controller environment. As discussed above, the traditional method may distribute tasks to each core based on the wireless band, which may waste resources. According to the present disclosure, the method and device not only distribute the tasks (e.g., compute) more uniformly among the cores so that throughput is increased, but also enable the programmability of the distribution schema with more advanced rules, such as controller load, controller capability, and controller rule.

In one example, a method comprises at least determining, by a processor of a network device, a plurality of controllers corresponding to a plurality of client devices; and distributing, by the processor, tasks corresponding to the plurality of client devices to multiple cores of the network device based on the plurality of controllers.

In another example, a device comprises at least: a memory; a processor executing instructions from the memory to: determine a plurality of controllers corresponding to a plurality of client devices, and distribute tasks corresponding to the plurality of client devices to multiple cores of the network device based on the plurality of controllers.

In another example, a non-transitory computer readable storage medium may be encoded with instructions executable by at least one hardware processor of a network device, the computer readable storage medium comprising instructions to: determine a plurality of controllers corresponding to a plurality of client devices, and distribute tasks corresponding to the plurality of client devices to multiple cores of the network device based on the plurality of controllers, wherein the plurality of client devices are assigned to the plurality of controllers according to advanced rules, and wherein the advanced rules includes controller load, controller capability and controller index.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like. For example, a “network device may refer to a network controller that comprises a hardware or a combination of hardware and software that enables connection between client devices and computer networks. In some implementations, a network device may refer to a server computing device (e.g., on-premise server, private, public, or hybrid cloud server) that comprises a hardware or a combination of hardware and software that can process and/or display network-related information. In some implementations, a network device may refer to an access point acting as a virtual master network controller among a cluster of access points.

It is appreciated that examples described herein below may include various components and features. Some of the components and features may be removed and/or modified without departing from a scope of the method, device and non-transitory computer readable storage medium for. It is also appreciated that, in the following description, numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example. As used herein, a component is a combination of hardware and software executing on that hardware to provide a given functionality.

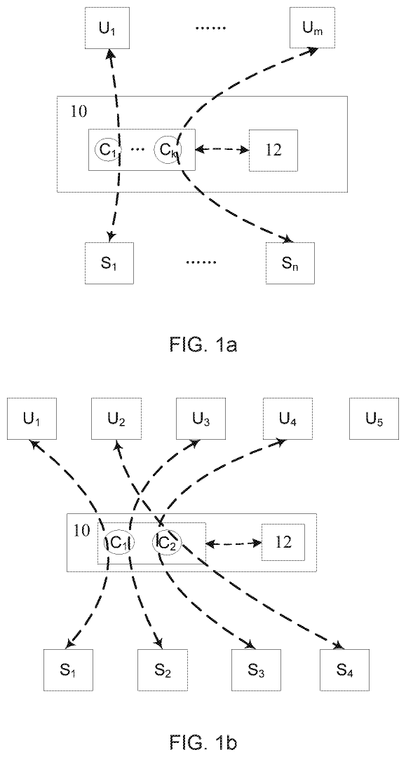

FIG. 1a is a diagram illustrating an example networking environment for distributing tasks according to the present disclosure. In this example network environment as shown in FIG. 1a, k cores C₁, . . . , Cₖ may be in a network device 10, e.g. an AP, and the network device 10 may have a processor 12. In addition, m controllers U₁, . . . , Uₘ may be in a cluster, and there may be n client devices S₁, . . . , Sₙ in the networking environment. Wherein, k, m and n are an integer greater than one, k, m and n may be equal or may be unequal one another, or any two of k, m and n may be equal.

As shown in FIG. 1a, the client devices S₁, . . . , Sₙ may be stations associated with one BSS (base station subsystem) of the network device 10. According to a core distribution method, such as a sequential distribution, each of the client devices may be assigned to a corresponding controller by the processor 12, and the corresponding controller may be distributed to one core by the processor 12. For example, if m is greater than n, the client device S₁ is assigned to the controller U₁, the client device S₂ may be assigned to the controller U₂, . . . , the client device Sₙ may be assigned to the controller Uₙ in sequence respectively. Furthermore, if m is greater than k and less than 2 k, the controller U₁ may be distributed to the core C₁, the controller U₂ may be distributed to the core C₂, . . . , the controller Uₖ may be distributed to the core Cₖ, the controller Uₖ₊₁ may be distributed to the core C₁, the controller Uₖ₊₂ may be distributed to the core C₂, . . . , the controller Uₘ may be distributed to the core Cₘ₋ₖ in sequence respectively. Similarly, if m is less than or equal to n, m is less than or equal to k, or m is greater than or equal to 2 k, and the like, the client devices may be assigned to the controllers, and the controllers may be distributed to the cores in sequence.

As a result, each of the n client devices may be assigned to one of the m controllers, and each of the controllers may be distributed to one of the k cores. Accordingly, when one client device sends packets to or from a network, e.g. WLAN system, the packets may be processed by one core corresponding to the controller that may be assigned to the client device.

In other cases, for example, the client devices may be assigned to the controllers by the processor 12 of the network device 10 according to the relation between m and n, and the controllers may be distributed to the cores by the processor 12 according to the relation between m and k. Furthermore, the processor 12 may assign the client devices to the controllers according to certain rules, such as controller load, controller capacity, etc.

Further, the numbers of the client devices or the number of the controller ay change over time. This case will be discussed in detail as shown in FIG. 1b.

FIG. 1b is a diagram illustrating example networking environment for distributing tasks according to the present disclosure.

As shown in FIG. 1b, two cores C1, C2 may be in an AP 10, and five controllers U1, U2, U3, U4, U5 may be in a cluster. In addition, there are four client devices S1, S2, S3, S4 in the networking environment.

As discussed above, for example, the client device S₁ may be assigned to the controller U₁, the client device S₂ may be assigned to the controller U₃, the client device S₃ may be assigned to the controller U₄ and the client device S₄ may be assigned to the controller U₂. The controllers U₁ and U₃ are distributed to the core C₁, and the controllers U₂ and U₄ are distributed to the core C₂. Accordingly, packets from or to the client device S₁ are processed by the core C₁ based on the controller U₁ corresponding to the client device S₁, packets from or to the client device S₂ are processed by the core C₁ based on the controller U₃ corresponding to the client device S₂, packets from or to the client device S₃ are processed by the core C₂ based on the controller U₄ corresponding to the client device S₃, and packets from or to the client device S₄ are processed by the core C₂ based on the controller U₂ corresponding to the client device S₄.

While, the processor 12 may detect the number of the controllers and the number of the client devices periodically. For example, if the controller U₂ are disabled, the client device S₄ may be redistributed to the controller U₅ by the processor 12 and the controller U₅ may be distributed to the core C₂. As a result, packets from or to the client device S₄ are processed by the core C₂ based on the controller U₅ corresponding to the client device S₄.

Further, if a new client device is added to the BSS of the network device, the new client device may be assigned (not shown in FIG. 1b) to the controller U₅ by the processor 12. The controller U₅ may be distributed to the core C₂ by the processor 12, and thus packets from or to the client device S₄ may be processed by the core C₂.

Thus, the cores of the network device 10 may be distributed dynamically and uniformly, so as to improve resource utilization.

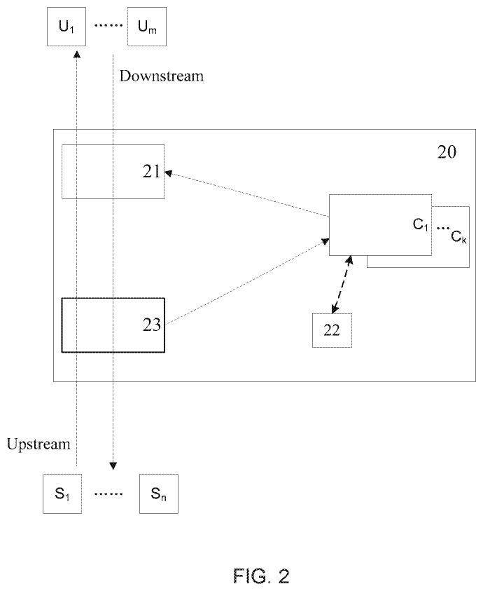

FIG. 2 is a diagram illustrating an example networking environment for processing downstream/upstream tasks according to the present disclosure. In this example networking environment, k cores C₁, . . . , Cₖ may be in a network device 20, and the network device 20 may have a processor 22. In addition, the network device 20 may have a driver 21 (e.g. an Ethernet driver) and a driver 23 (e.g. a WLAN driver).

As discussed above, each of the client devices may be assigned to a corresponding controller by the processor 22, and the corresponding controller may be distributed to one core by the processor 22.

In some examples, in an upstream process, when one client device, e.g. client device S₂, sends a frame, the driver 23 may receive the frame from the client device S₂ firstly, then the processor 22 may capture information of a controller, e.g. controller U₃ corresponding to the client device S₂ according to information of the client device S₂, e.g. MAC address of the client device S₂. For example, the processor 22 may calculates an index of the controller U₃ corresponding to the client device S₂ according to MAC address of the client device S₂. A corresponding core of the network device 20, e.g. the core C₂ assigned for the controller U₃ is scheduled to process the frame by the processor 22 according to the information of the controller U₃, e.g. the index. The corresponding core C₂ then may take the frame over for processing, and may encapsulate the frame in a tunnel to the controller U₃. Finally, the encapsulated frame may be sent to the network (e.g. wired network, wireless network) by means of the driver 21.

In some examples, in a downstream process, the network device 20 may receive packets in a tunnel from one controller (e.g. controller U₅) by means of the driver 21, the driver 21 may detect and obtain information of the packets, such as the source addresses (e.g., IP address) of the packets, so as to find out from which AC the packets are. A corresponding core (e.g. core C₂) assigned for the controller U₅ may be scheduled to process the frame by the processor 22, take the packets over for processing, decapsulate the packets and send the decapsulated packets to a corresponding client device according to the source addresses by means of a driver 23, e.g. WLAN driver.

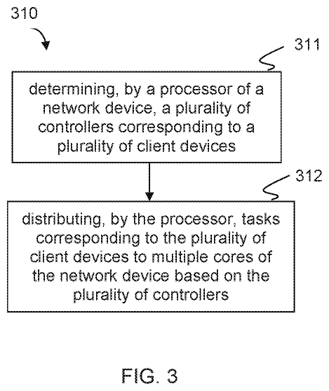

FIG. 3 is a flow chart illustrating an example method of distributing tasks according to the present disclosure. Referring to FIG. 3:

The method 310 comprises determining, by a processor of a network device, a plurality of controllers corresponding to a plurality of client devices, at 311.

The method 310 comprises distributing, by the processor, tasks corresponding to the plurality of client devices to multiple cores of the network device based on the plurality of controllers.

As discussed above, each of the plurality of client devices being distributed to the plurality of controllers, and each of the plurality of controllers being assigned to a corresponding core.

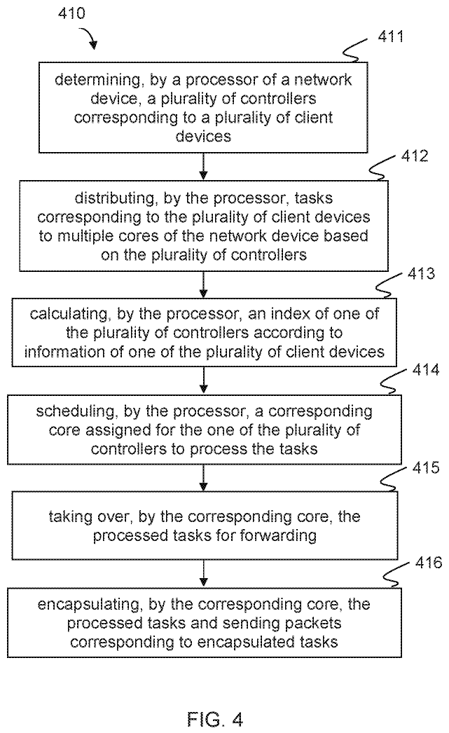

FIG. 4 is a flow chart illustrating another example method of distributing tasks according to the present disclosure. Referring to FIG. 4:

The method 410 comprises determining, by a processor of a network device, a plurality of controllers corresponding to a plurality of client devices, at 411.

The method 410 comprises distributing, by the processor, tasks corresponding to the plurality of client devices to multiple cores of the network device based on the plurality of controllers, at 412.

The method 410 comprises calculating, by the processor, an index of one of the plurality of controllers according to information of one of the plurality of client devices, at 413.

In some examples, the information of the client device includes MAC address of the client device.

The method 410 comprises scheduling, by the processor, a corresponding core assigned for the one of the plurality of controllers to process the tasks, at 414.

The method 410 comprises taking over, by the corresponding core, the processed tasks for forwarding, at 415.

In some examples, tasks from and to the client device are tunneled between an AP and AC corresponding to the client device.

The method 410 comprises encapsulating, by the corresponding core, the processed tasks and sending packets corresponding to the encapsulated tasks, at 416.

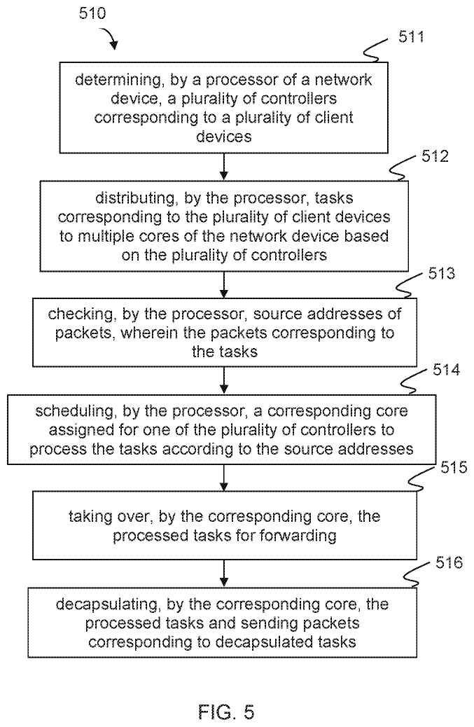

FIG. 5 is a flow chart illustrating another example method of distributing tasks according to the present disclosure. Referring to FIG. 5:

The method 510 comprises determining, by a processor of a network device, a plurality of controllers corresponding to a plurality of client devices, at 511.

The method 510 comprises distributing, by the processor, tasks corresponding to the plurality of client devices to multiple cores of the network device based on the plurality of controllers, at 512.

The method 510 comprises checking, by the processor, source addresses of packets, at 513, wherein the packets corresponding to the tasks.

In some examples, the source addresses include the IP addresses of the packets.

The method 510 comprises scheduling, by the processor, a corresponding core assigned for one of the plurality of controllers to process the tasks according to the source addresses, at 514.

The method 510 comprises taking over, by the corresponding core, the processed tasks for forwarding, at 515.

In some examples, each of tasks from and to the client device are tunneled between an AP and AC corresponding to the client device.

The method 510 comprises decapsulating, by the corresponding core, the processed tasks and sending packets corresponding to the decapsulated tasks, at 516.

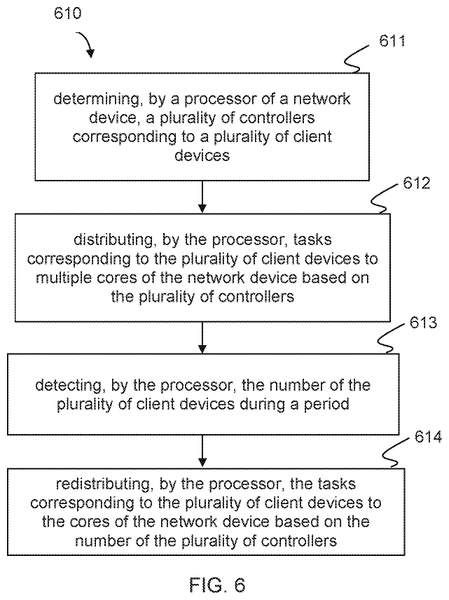

FIG. 6 is a flow chart illustrating another example method of distributing tasks according to the present disclosure. Referring to FIG. 6:

The method 610 comprises determining, by a processor of a network device, a plurality of controllers corresponding to a plurality of client devices, at 611.

The method 610 comprises distributing, by the processor, tasks corresponding to the plurality of client devices to multiple cores of the network device based on the plurality of controllers, at 612.

The method 610 comprises detecting, by the processor, the number of the plurality of client devices during a period, at 613.

In some examples, the period may include one hour, one day, one week, etc.

The method 610 comprises redistributing, by the processor, the tasks corresponding to the plurality of client devices to the cores of the network device based on the number of the plurality of controllers, at 614.

In some examples, the number of the plurality of client devices may change over time. If the number of the plurality of client devices changes, the plurality of client devices may be redistributed to the plurality of controllers, so that the cores are always distributed uniformly.

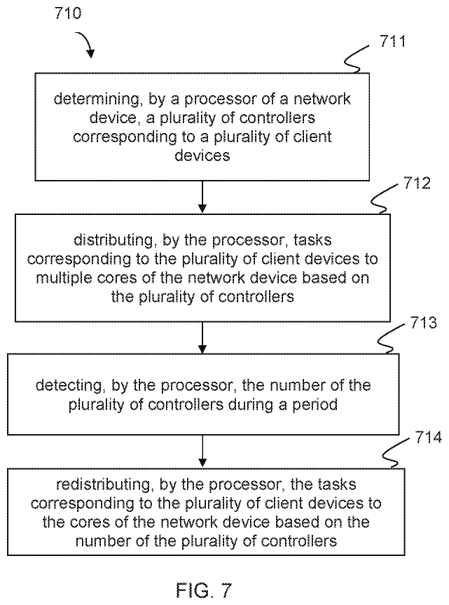

FIG. 7 is a flow chart illustrating another example method of distributing tasks according to the present disclosure. Referring to FIG. 7:

The method 710 comprises determining, by a processor of a network device, a plurality of controllers corresponding to a plurality of client devices, at 711.

The method 710 comprises distributing, by the processor, tasks corresponding to the plurality of client devices to multiple cores of the network device based on the plurality of controllers, at 712.

The method 710 comprises detecting, by the processor, the number of the plurality of controllers during a period, at 713.

In some example, the period may include one hour, one day, one week, etc.

The method 710 comprises redistributing, by the processor, the tasks corresponding to the plurality of client devices to the cores of the network device based on the number of the plurality of controllers, at 714.

In some examples, the number of the plurality of controllers may change over time. If the number of the plurality of controllers changes, the plurality of client devices may be redistributed to the plurality of controllers, so that the cores are always distributed uniformly.

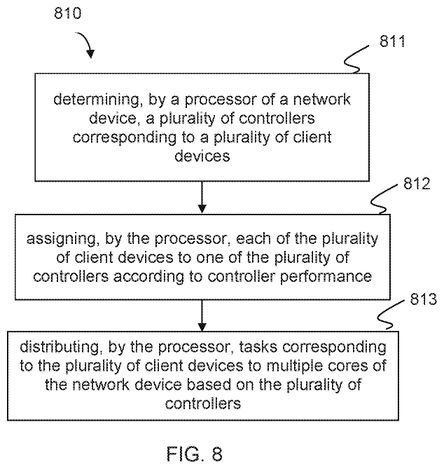

FIG. 8 is a flow chart illustrating another example method of distributing tasks according to the present disclosure. Referring to FIG. 8:

The method 810 comprises determining, by a processor of a network device, a plurality of controllers corresponding to a plurality of client devices, at 811.

The method 810 comprises assigning, by the processor, each of the plurality of client devices to one of the plurality of controllers according to controller performance, at 812.

In some examples, the controller performance may include controller capability, controller load, etc.

The method 810 comprises distributing, by the processor, tasks corresponding to the plurality of client devices to multiple cores of the network device based on the plurality of controllers, at 813.

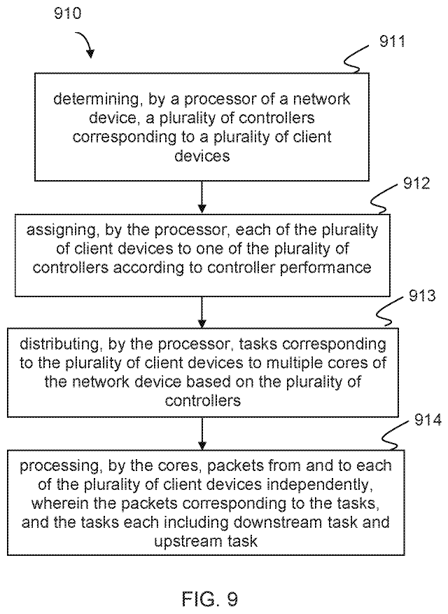

FIG. 9 is a flow chart illustrating another example method of distributing tasks according to the present disclosure. Referring to FIG. 9:

The method 910 comprises determining, by a processor of a network device, a plurality of controllers corresponding to a plurality of client devices, at 911.

The method 910 comprises assigning, by the processor, each of the plurality of client devices to one of the plurality of controllers according to controller performance, at 912.

In some examples, the controller performance may include controller capability, controller load, etc.

The method 910 comprises distributing, by the processor, tasks corresponding to the plurality of client devices to multiple cores of the network device based on the plurality of controllers, at 913.

The method 910 comprises processing, by the cores, packets from and to each of the plurality of client devices independently, at 914, wherein the packets corresponding to the tasks, and the tasks each including downstream task and upstream task.

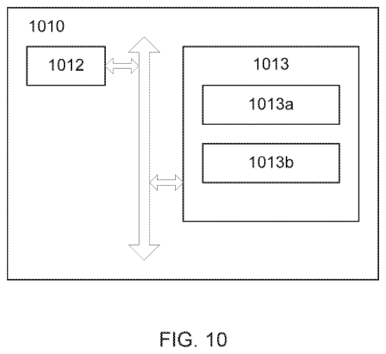

FIG. 10 is a block diagram of an example device according to the present disclosure. Referring to FIG. 10, the device 1010 may include a processor 1012 and a non-transitory computer readable storage medium 1013.

The non-transitory computer readable storage medium 1013 may store instructions executable for the processor 1012.

The instructions include determining instructions 1013a that, when executed by the processor 1012, may cause the processor 1012 to determine a plurality of controllers corresponding to a plurality of client devices.

The instructions include distributing instructions 1013b that, when executed by the processor 1012, may cause the processor 1012 to distribute tasks corresponding to the plurality of client devices to multiple cores of the network device based on the plurality of controllers.

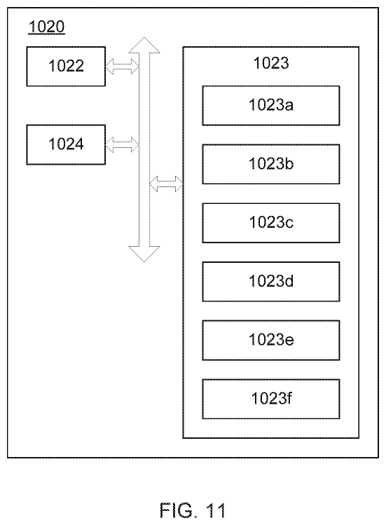

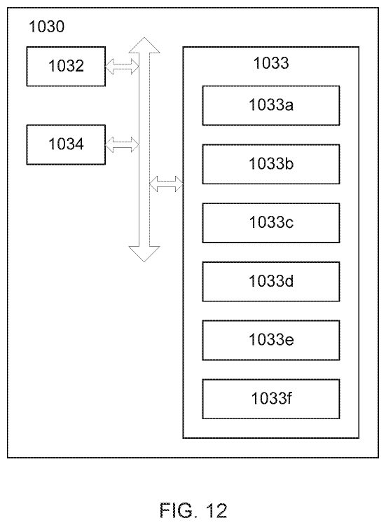

FIG. 11 is a block diagram of an example device according to the present disclosure. Referring to FIG. 11, the device 1020 may include a processor 1022, a non-transitory computer readable storage medium 1023 and a memory 1024.

The non-transitory computer readable storage medium 1023 may store instructions executable for the processor 1022, and the memory 1024 may store packet, index, etc.

The instructions include determining instructions 1023a that, when executed by the processor 1022, may cause the processor 1022 to determine a plurality of controllers corresponding to a plurality of client devices.

The instructions include distributing instructions 1023b that, when executed by the processor 1022, may cause the processor 1022 to distribute tasks corresponding to the plurality of client devices to multiple cores of the network device based on the plurality of controllers.

The instructions include calculating instructions 1023c that, when executed by the processor 1022, may cause the processor 1022 to calculate an index of one of the plurality of controllers according to information of one of the plurality of client devices.

In some examples, the information of the client device includes MAC address of the client device.

The instructions include scheduling instructions 1023d that, when executed by the processor 1022, may cause the processor 1022 to schedule a corresponding core assigned for one of the plurality of controllers to process the tasks.

The instructions include taking-over instructions 1023e that, when executed by the processor 1022, cause the corresponding core to take over the processed tasks for forwarding.

In some examples, tasks from and to the client device are tunneled between an AP and AC corresponding to the client device.

The instructions include encapsulating instructions 1033f that, when executed by the processor 1022, may cause the corresponding core to encapsulate the processed tasks and send packets corresponding to the encapsulated tasks.

FIG. 12 is a block diagram of an example device according to the present disclosure. Referring to FIG. 12, the device 1030 may include a processor 1032, a non-transitory computer readable storage medium 1033 and a memory 1034.

The non-transitory computer readable storage medium 1033 may store instructions executable for the processor 1032, and the memory 1034 may store packet, index, etc.

The instructions include determining instructions 1033a that, when executed by the processor 1032, may cause the processor 1032 to determine a plurality of controllers corresponding to a plurality of client devices.

The instructions include distributing instructions 1033b that, when executed by the processor 1032, may cause the processor 1032 to distribute tasks corresponding to the plurality of client devices to multiple cores of the network device based on the plurality of controllers.

The instructions include checking instructions 1033c that, when executed by the processor 1032, may cause the processor 1032 to check source addresses of packets corresponding to the tasks.

In some example, the source addresses include the IP addresses of the packets.

The instructions include scheduling instructions 1033d that, when executed by the processor 1032, may cause the processor 1032 to schedule a corresponding core assigned for one of the plurality of controllers to process the tasks according to the source addresses.

The instructions include taking-over instructions 1033e that, when executed by the processor 1032, may cause the corresponding core to take over the processed tasks for forwarding.

In some examples, tasks from and to the client device are tunneled between an AP and AC corresponding to the client device.

The instructions include decapsulating instructions 1033f that, when executed by the processor 1032, may cause the corresponding core to decapsulate the processed tasks and send packets corresponding to the decapsulated tasks.

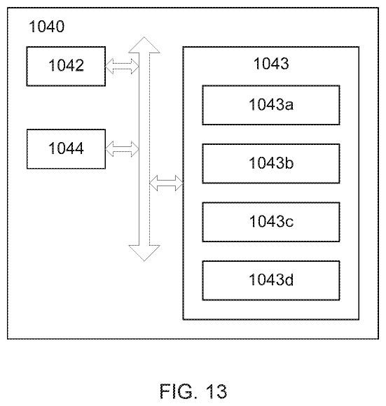

FIG. 13 is a block diagram of an example device according to the present disclosure. Referring to FIG. 13, the device 1040 may include a processor 1042, a non-transitory computer readable storage medium 1043 and a memory 1044.

The non-transitory computer readable storage medium 1043 may store instructions executable for the processor 1042, and the memory 1044 stores packets, the number of the client device, the number of the controllers, etc.

The instructions include determining instructions 1043a that, when executed by the processor 1042, may cause the processor 1042 to determine a plurality of controllers corresponding to a plurality of client devices.

The instructions include distributing instructions 1043b that, when executed by the processor 1042, may cause the processor 1042 to distribute tasks corresponding to the plurality of client devices to multiple cores of the network device based on the plurality of controllers.

The instructions include detecting instructions 1043c that, when executed by the processor 1042, may cause the processor 1042 to detect the number of the plurality of client device during a period.

In some examples, the period may include one hour, one day, one week, etc.

The instructions include redistributing instructions 1043d that, when executed by the processor 1042, may cause the processor 1042 to redistribute the tasks corresponding to the plurality of client devices to the cores of the network device based on the number of the plurality of controllers.

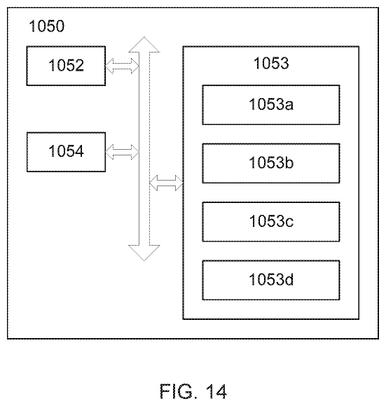

FIG. 14 is a block diagram of an example device according to the present disclosure. Referring to FIG. 14, the device 1050 may include a processor 1052, a non-transitory computer readable storage medium 1053 and a memory 1054.

The non-transitory computer readable storage medium 1053 may store instructions executable for the processor 1052, and the memory 1054 stores packets, the number of the client devices, the number of controllers, etc.

The instructions include determining instructions 1053a that, when executed by the processor 1052, may cause the processor 1052 to determine a plurality of controllers corresponding to a plurality of client devices.

The instructions include distributing instructions 1053b that, when executed by the processor 1052, may cause the processor 1052 to distribute tasks corresponding to the plurality of client devices to multiple cores of the network device based on the plurality of controllers.

The instructions include detecting instructions 1053c that, when executed by the processor 1052, may cause the processor 1052 to detect the number of the plurality of controllers during a period.

In some examples, the period may include one hour, one day, one week, etc.

The instructions include redistributing instructions 1053d that, when executed by the processor 1052, may cause the processor 1052 to redistribute the tasks corresponding to the plurality of client devices to the cores of the network device based on the number of the plurality of controllers.

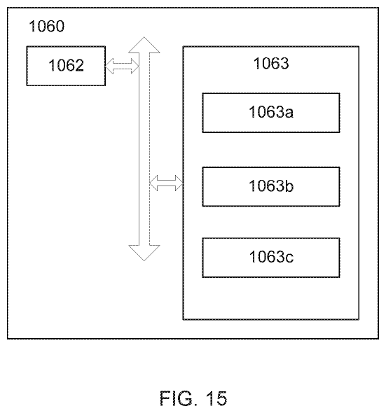

FIG. 15 is a block diagram of an example device according to the present disclosure. Referring to FIG. 15, the device 1060 may include a processor 1062 and a non-transitory computer readable storage medium 1063.

The non-transitory computer readable storage medium 1063 may store instructions executable for the processor 1062.

The instructions include determining instructions 1063a that, when executed by the processor 1062, may cause the processor 1062 to determine a plurality of controllers corresponding to a plurality of client devices.

The instructions include assigning instructions 1063b that, when executed by the processor 1062, may cause the processor 1062 to assign each of the plurality of client devices to one of the plurality of controllers according to controller performance.

In some examples, the controller performance may include controller capability, controller load, etc.

The instructions include distributing instructions 1063c that, when executed by the processor 1062, may cause the processor 1062 to distribute tasks corresponding to the plurality of client devices to multiple cores of the network device based on the plurality of controllers.

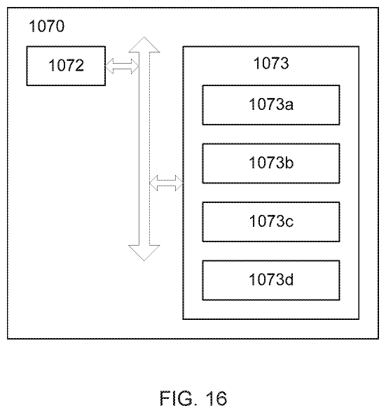

FIG. 16 is a block diagram of an example device according to the present disclosure. Referring to FIG. 16, the device 1070 may include a processor 1072 and a non-transitory computer readable storage medium 1073.

The non-transitory computer readable storage medium 1073 may store instructions executable for the processor 1072.

The instructions include determining instructions 1073a that, when executed by the processor 1072, may cause the processor 1072 to determine a plurality of controllers corresponding to a plurality of client devices.

The instructions include assigning instructions 1073b that, when executed by the processor 1072, may cause the processor 1072 to assign each of the plurality of client devices to one of the plurality of controllers according to controller performance.

In some examples, the controller performance may include controller capability, controller load, etc.

The instructions include distributing instructions 1073c that, when executed by the processor 1072, may cause the processor 1072 to distribute tasks corresponding to the plurality of client devices to multiple cores of the network device based on the plurality of controllers.

The instructions include processing instructions 1073d that, when executed by the processor 1072, may cause the processor 1072 to process packets from and to each of the plurality of client devices independently, wherein the packets corresponding to the tasks, and the tasks each including downstream task and upstream task.

Flow diagrams herein are illustrated in accordance with various examples of the present disclosure. The flow diagrams represent processes that may be utilized in conjunction with various systems and devices as discussed with reference to the preceding figures. While illustrated in a particular order, the flow diagrams are not intended to be so limited. Rather, it is expressly contemplated that various processes may occur in different orders and/or simultaneously with other processes than those illustrated. As such, the sequence of operations described in connection with FIGS. 3-9 are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples.

Although certain embodiments have been illustrated and described herein, it will be greatly appreciated by those of ordinary skill in the art that a wide variety of alternate and/or equivalent embodiments or implementations calculated to achieve the same purposes may be substituted for the embodiments shown and described without departing from the scope of this disclosure. Those with skill in the art will readily appreciate that embodiments may be implemented in a variety of ways. This application is intended to cover adaptions or variations of the embodiments discussed herein. Therefore, it is manifestly intended that embodiments be limited only by the claims and equivalents thereof.

What is claimed is:

1. A method, comprising:
determining, by a processor of a network device, a plurality of controllers corresponding to a plurality of client devices; and
distributing, by the processor, tasks corresponding to the plurality of client devices to multiple cores of the network device based on the plurality of controllers.

2. The method of claim 1, further comprising:
calculating, by the processor, an index of one of the plurality of controllers according to information of one of the plurality of client devices;
scheduling, by the processor, a corresponding core assigned for the one of the plurality of controllers to process the tasks;
taking over, by the corresponding core, the processed tasks for forwarding; and
encapsulating, by the corresponding core, the processed tasks and sending packets corresponding to encapsulated tasks.

3. The method of claim 1, further comprising:
checking, by the processor, source addresses of packets, wherein the packets corresponding to the tasks;
scheduling, by the processor, a corresponding core assigned for one of the plurality of controllers to process the tasks according to the source addresses;
taking over, by the corresponding core, the processed tasks for forwarding; and
decapsulating, by the corresponding core, the processed tasks and sending packets corresponding to decapsulated tasks.

4. The method of claim 1, further comprising:
detecting, by the processor, the number of the plurality of client devices during a period; and
redistributing, by the processor, the tasks corresponding to the plurality of client devices to the cores of the network device based on the number of the plurality of controllers.

5. The method of claim 1, further comprising:
detecting, by the processor, the number of the plurality of controllers during a period; and
redistributing, by the processor, the tasks corresponding to the plurality of client devices to the cores of the network device based on the number of the plurality of controllers.

6. The method of claim 1, further comprising:
assigning, by the processor, each of the plurality of client devices to one of the plurality of controllers according to controller performance.

7. The method of claim 6, further comprising:
processing, by the cores, packets from and to each of the plurality of client devices independently, wherein the packets corresponding to the tasks, and the tasks each including downstream task and upstream task.

8. A device, comprising at least:
a memory;
a processor executing instructions from the memory to:
determine a plurality of controllers corresponding to a plurality of client devices; and
distribute tasks corresponding to the plurality of client devices to multiple cores of the network device based on the plurality of controllers.

9. The device of claim 8, wherein the processor further executes the instructions from the memory to:
calculate an index of one of the plurality of controllers according to information of one of the plurality of client devices;
schedule a corresponding core assigned for the one of the plurality of controllers to process the tasks;
cause the corresponding core to take over the processed tasks for forwarding; and
cause the corresponding core to encapsulate the processed tasks and send packets corresponding to encapsulated tasks.

10. The device of claim wherein the processor further executes the instructions from the memory to:
check source addresses of packets, wherein the packets corresponding to the tasks;
schedule a corresponding core assigned for one of the plurality of controllers to process the tasks according to the source addresses;
cause the corresponding core to take over the processed tasks for forwarding; and
cause the corresponding core to decapsulating the processed tasks and send packets corresponding to decapsulated tasks.

11. The device of claim 8, wherein the processor further executes the instructions from the memory to:
detect the number of the plurality of client devices during a period; and
redistribute the tasks corresponding to the plurality of client devices to the cores of the network device based on the number of the plurality of controllers.

12. The device of claim 8, wherein the processor further executes the instructions from the memory to:
detect the number of the plurality of controllers during a period; and
redistribute the tasks corresponding to the plurality of client devices to the cores of the network device based on the number of the plurality of controllers.

13. The device of claim 8, wherein the processor further executes the instructions from the memory to:
assign each of the plurality of client devices to one of the plurality of controllers according to controller performance.

14. The device of claim 13, wherein the processor further executes the instructions from the memory to:
cause the cores to process packets from and to each of the plurality of client devices independently, wherein the packets corresponding to the tasks, and the tasks including downstream tasks and upstream tasks.

15. A non-transitory computer readable storage medium encoded with instructions executable by at least one hardware processor of a network device, the computer readable storage medium comprising instructions to:
determine a plurality of controllers corresponding to a plurality of client devices; and
distribute tasks corresponding to the plurality of client devices to multiple cores of the network device based on the plurality of controllers,
wherein the plurality of client devices are assigned to the plurality of controllers according to advanced rules, wherein the advanced rules includes controller load, controller capability and/or controller index.
